(19) United States
(12) Patent Application Publication
(10) Pub. No.: US 2009/0052299 A1
(43) Pub. Date: Feb. 26, 2009

(54) OPTICAL INFORMATION RECORDING MEDIUM AND INFORMATION RECORDING METHOD

(75) Inventors: Tetsuya Watanabe, Kanagawa (JP); Keita Takahashi, Kanagawa (JP); Kazutoshi Katayama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/281,951

(22) PCT Filed: Mar. 5, 2007
(86) PCT No.: PCT/JP2007/054750

§ 371 Date: Sep. 5, 2008

(30) Foreign Application Priority Data
Mar. 6, 2006 (JP) 2006-060245

(51) Int. Cl. G11B 5/127

(52) U.S. Cl. 369/100; G9B/5.04

(57) ABSTRACT

There is provided an optical information recording medium including, on a substrate, a recording layer in which information can be recorded by irradiating a laser beam having a wavelength of 440 nm or less, wherein the recording layer includes an oxonol dye that has a maximum absorption wavelength longer than the wavelength of the laser beam. There is also provided an information recording method including irradiating a laser beam having a wavelength of 440 nm or less to the optical information recording medium to record information.

### TECHNICAL FIELD

The present invention relates to an optical information recording medium and an information recording method which allow recording and reproduction of information using a laser beam. The invention, in particular, relates to a heat-mode optical information recording medium and information recording method suitable for information recording using a laser beam having a wavelength of 440 nm or less.

### BACKGROUND ART

Optical information recording media (optical disks) where information is recorded only once by laser beam irradiation are known. Such optical disks, often called write-once CDs (so-called CD-R), have a typical structure wherein a recording layer containing an organic dye, a light-reflective layer (a reflective layer) of a metal such as gold, and a resin protective layer are formed on a transparent disk substrate in that order. Information is recorded on a CD-R by irradiation of a laser beam in the near-infrared region onto the CD-R (normally, a laser beam with a wavelength of around 780 nm). In the irradiated area of the recording layer, light is absorbed, resulting in localized increase in temperature and changing of its physical or chemical properties (e.g., pit generation). Because of these physical or chemical changes, the optical properties are changed, whereby information is recorded. Reading of the information (reproduction) is also carried out by irradiating a laser beam having the same wavelength as that of the recording laser beam. Information is reproduced by detecting the difference in reflectance between areas where the optical properties of the recording layer have been changed (recorded area) and areas where they are not changed (unrecorded area).

Recently, networks such as the internet and high-definition TVs are rapidly becoming more and more popular. HDTV (High-Definition Television) broadcasting has also resulted in increased need for a large-capacity recording medium for recording image information more cost-effectively. CD-Rs as described above, and write-once digital-versatile-disks (so-called DVD-Rs), which allow high-density recording by using a visible laser beam (630 to 680 nm), have been established as large-capacity recording media to some extent, but still do not have a recording capacity large enough to cope with future requirements. Optical disks having higher recording density and larger recording capacity that use a laser beam having a wavelength shorter than that for DVD-Rs have been studied, and, for example, optical recording disks of the Blu-ray Disk system or the HD DVD system that use a blue laser having a wavelength of 405 nm have been commercialized or studied.

A method of recording information on and reproducing the information from an optical information recording medium including an organic dye recording layer by irradiating the recording layer with a laser having a wavelength of 530 nm or less from the recording layer side to the light reflective layer side has been disclosed. This method comprises irradiating, with a blue laser (wavelength of 400 to 430 nm, 488 nm) or blue-green laser (wavelength of 515 nm), an optical disk including a recording layer comprising a dye such as a porphyrin compound, an azo dye, a metallic azo dye, a quinophthalone dye, a trimethine cyanine dye, a dicyanovinylphenyl skeleton dye, a coumarin compound, or a naphthalocyanine compound. In addition, a method of recording information and reproducing the information by irradiating an optical disk having a recording layer including an oxonol dye with a laser having a wavelength of 550 nm or less has been disclosed.

As related art of dyes for blue laser optical recording discs, those described in Japanese Patent Application Laid-Open (JP-A) Nos. 2001-287460, 2001-287465, 2001-253171, 2001-39034, 2000-318313, 2000-318312, 2000-280621, 2000-280620, 2000-263939, 2000-222772, 2000-222771, 2000-218940, 2000-158818, 2000-149320, 2000-108513, 2000-113504, 2002-301870 and 2001-287465, U.S. Patent No. 2002/76648A1, JP-A Nos. 2003-94828, 2001-71638 and 2002-74740 can be exemplified.

Furthermore, in JP-A Nos. 2000-113516, 2001-283464 and 2000-173096, optical information recording media capable of forming an image by a laser beam are disclosed.

However, according to investigations by the present inventors, the recording characteristics of optical discs that use known dyes described in the above publications are not at a satisfactory level. Furthermore, optical discs that use oxonol dyes disclosed in JP-A No. 2001-71638 are not satisfactory from a practical viewpoint because the oxonol dyes used in this patent document tend to crystallize.

An optical recording medium containing a dye that has a maximum absorption wavelength longer than the wavelength of a laser beam has been disclosed in JP-A No. 2002-74740. However, in this patent document, it is not disclosed what dye material can realize this; accordingly, in actuality, an optical recording medium having excellent performance cannot be produced according to this patent document.

### DISCLOSURE OF INVENTION

The invention provides an optical information recording medium comprising, on a substrate, a recording layer in which information can be recorded by irradiating a laser beam having a wavelength of 440 nm or less, wherein the recording layer comprises an oxonol dye that has a maximum absorption wavelength longer than the wavelength of the laser beam.

Since an oxonol dye is used, high light resistance and high durability and excellent recording characteristics can be obtained. Furthermore, an oxonol dye of which maximum absorption wavelength is longer than the wavelength of the recording laser beam has a longer conjugate system in comparison with that of an oxonol dye having a shorter maximum absorption wavelength; accordingly, owing to the high absorption coefficient, the modulation width at laser recording becomes larger and the hygrothermal stability of the dye molecule is high. Thereby, an optical information recording medium can be obtained in which information can be properly recorded and reproduced at high density by irradiating a laser beam of 440 nm or less and which is excellent in storability.

An optical information recording medium of the invention preferably has at least one of the following first to sixth aspects.

(1) The first aspect is an aspect where the oxonol dye is represented by the following formula (I).

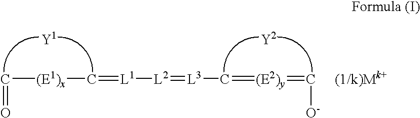

In the formula (I), L¹, L² and L³ each independently represent a methine chain that may have a substituent group, Y¹ and Y² each represent an atomic group necessary for forming a carbon ring or a heterocyclic ring together with C-(E¹)ₓ-C or C=(E²)_{y}=C, E¹ and E² each represent an atomic group necessary for completing a conjugate double bond chain, x and y each denote 0 or 1, M^{k+} represents a cation and k denotes a number necessary for neutralizing charges of the entire molecule.

Such oxonol dyes preferably have a trimethine chain, and further preferably have a 5- or 6-membered heterocyclic group as an end group.

The oxonol dyes represented by the formula (I) have an absorption wavelength suitable for recording by a laser beam having a wavelength of 440 nm or less; accordingly, the oxonol dyes can be preferably used in optical information recording media of the invention.

(2) The second aspect is an aspect where an anion moiety in the formula (I) is represented by the following formula (I-1).

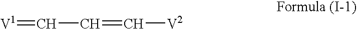

In the formula (I-1), V¹ is any one selected from the following group 1, and V² is any one selected from the following group 2.

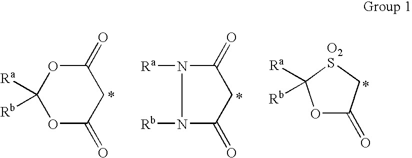

In the foregoing chemical formulae in group 1, R^{a} and R^{b} each independently represent a hydrogen atom or a substituent group, and * represents a bonding position in formula (I-1).

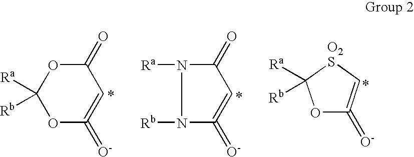

In the foregoing chemical formulae in group 2, R^{a} and R^{b} each independently represent a hydrogen atom or a substituent group, and * represents a bonding position in formula (I-1).

An anion moiety represented by the formula (I-1) has particularly excellent thermal decomposition characteristics (being readily thermally decomposed upon heating); accordingly, the anion moiety can be preferably used in the optical information recording media of the invention.

(3) The third aspect is an aspect where a cation moiety in the formula (I) is represented by the following formula (I-3).

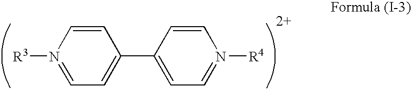

In the formula (I-3), R³ and R⁴ each independently represent an aryl group that may be substituted.

A cation moiety represented by the formula (I-3) can inhibit dye fading and thereby can improve the storability of the optical information recording media.

(4) The fourth aspect is an aspect where a light reflective layer made of metal is provided in addition to the recording layer. When the light reflective layer is provided, the reflectance when information is reproduced can be improved.

(5) The fifth aspect is an aspect where a protective layer is provided in addition to the recording layer. When the protective layer is provided, various layers can be protected.

(6) The sixth aspect is an aspect where the substrate is a transparent disc substrate having a groove (pre-groove) having a track pitch in the range of 0.2 to 0.5 μm on a surface thereof, and the recording layer is formed on a side where the pre-groove is formed.

Furthermore, the invention provides an information recording method including irradiating a laser beam having a wavelength of 440 nm or less to the above-mentioned optical information recording medium of the invention to record information. In the information recording method of the invention, the above-mentioned optical information recording medium of the invention is used; accordingly, high density information recording and reproducing can be properly carried out.

### BEST MODE FOR CARRYING OUT THE INVENTION

The optical information recording medium of the invention includes, on a substrate, a recording layer in which information can be recorded by irradiating a laser beam having a wavelength of 440 nm or less, wherein the recording layer contains an oxonol dye of which maximum absorption wavelength is longer than the wavelength of the laser beam.

Since an oxonol dye is used, high light resistance and high durability can be obtained, and excellent recording characteristics can be obtained. Furthermore, an oxonol dye of which maximum absorption wavelength is longer than the wavelength of the recording laser beam has a longer conjugate system in comparison with that of an oxanol dye of which maximum absorption wavelength is shorter than the wavelength of the recording laser beam; accordingly, owing to the high absorption coefficient, the modulation width at laser recording becomes larger and the hygrothermal stability of the dye molecule is high. Thereby, an optical information recording medium can be obtained in which information can be properly recorded and reproduced at high density by irradiating a laser beam of 440 nm or less and which is excellent in storability.

As such oxonol dyes, oxonol dyes represented by the following formula (I) are particularly preferable.

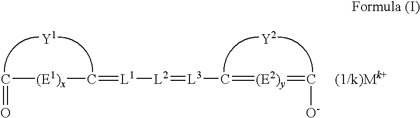

In the formula (I), L¹, L² and L³ each independently represent a methine chain that may have a substituent group, Y¹ and Y² each represent an atomic group necessary for forming a carbon ring or a heterocyclic ring together with C-(E¹)ₓ-C or C=(E²)_{y}=C, E¹ and E² each represent an atomic group necessary for completing a conjugate double bond chain, x and y each denote 0 or 1, M^{k+} represents a cation and k denotes a number necessary for neutralizing charges of the entire molecule.

A dye compound according to the invention includes an anionic dye component (hereinafter, simply referred to as an anion moiety) and a cationic component (hereinafter simply referred to as a cation moiety). In the beginning, the anion moiety will be detailed. In the formula, L¹, L² and L³ each independently represent a methine chain that may have a substituent group and, as the substituent group, for instance, the followings can be exemplified.

That is, examples thereof include a substituted or unsubstituted straight chain, branched chain or cyclic alkyl group having 1 to 18 carbon atoms (preferably 1 to 8 carbon atoms) (for instance, methyl, ethyl, propyl, isopropyl, n-butyl, isobutyl, sec-butyl, t-butyl, cyclohexyl, methoxyethyl, ethoxycarbonylethyl, cyanoethyl, diethylaminoethyl, hydroxyethyl, chloroethyl, acetoxyethyl, trifluoromethyl and aralkyl group); an alkenyl group having 2 to 18 carbon atoms (preferably 2 to 8 carbon atoms) (for instance, a vinyl group); an alkynyl group having 2 to 18 carbon atoms (preferably 2 to 8 carbon atoms) (for instance, an ethynyl group); a substituted or unsubstituted aryl group having 6 to 18 carbon atoms (preferably 6 to 10 carbon atoms) (for instance, phenyl, 4-methylphenol, 4-methoxyphenyl, 4-carboxyphenyl and 3,5-dicarboxyphenyl);

a substituted or unsubstituted acyl group having 2 to 18 carbon atoms (preferably 2 to 8 carbon atoms) (for instance, acetyl, propionyl, butanoyl and chloroacetyl); a substituted or unsubstituted alkyl or arylsulfonyl group having 1 to 18 carbon atoms (preferably 1 to 8 carbon atoms) (for instance, methanesulfonyl and p-toluenesulfonyl); an alkylsulfinyl group having 1 to 18 carbon atoms (preferable 1 to 8 carbon atoms) (for instance, methanesulfinyl, ethanesulfinyl and octanesulfinyl); an alkoxycarbonyl group having 2 to 18 carbon atoms (preferably 2 to 8 carbon atoms) (for instance, methoxycarbonyl, ethoxycarbonyl and buthoxycarbonyl); an aryloxycarbonyl group having 7 to 18 carbon atoms (preferably 7 to 12 carbon atoms) (for instance, phenoxycarbonyl, 4-methylphenoxycarbonyl and 4-methoxyphenylcarbonyl); a substituted or unsubstituted alkoxy group having 1 to 18 carbon atoms (preferably 1 to 8 carbon atoms) (for instance, methoxy, ethoxy, n-butoxy and methoxyethoxy); a substituted or unsubstituted aryloxy group having 6 to 18 carbon atoms (preferably 6 to 10 carbon atoms) (for instance, phenoxy and 4-methoxyphenoxy); an alkylthio group having 1 to 18 carbon atoms (preferably 1 to 8 carbon atoms) (for instance, methylthio and ethylthio); an arylthio group having 6 to 10 carbon atoms (preferably 6 to 8 carbon atoms) (for instance, phenylthio);

a substituted or unsubstituted acyloxy group having 2 to 18 carbon atoms (preferably 2 to 8 carbon atoms) (for instance acetoxy, ethylcarbonyloxy, cyclohexylcarbonyloxy, benzoyloxy and chloroacetyloxy); a substituted or unsubstituted sulfonyloxy group having 1 to 18 carbon atoms (preferably 1 to 8 carbon atoms) (for instance, methanesulfonyloxy); a substituted or a unsubstituted carbamoyloxy group having 2 to 18 carbon atoms (preferably 2 to 8 carbon atoms) (for instance, methylcarbamoyloxy and diethylcarbamoyloxy); an unsubstituted amino group or a substituted amino group having 1 to 18 carbon atoms (preferably 1 to 8 carbon atoms) (for instance, methylamino, dimethylamino, diethylamino, anilino, methoxyphenylamino, chlorophenylamino, pyridylamino, methoxycarbonylamino, n-butoxycarbonylamino, phenoxycarbonylamino, phenylcarbamoylamino, ethylthiocarbamoylamino, methylsulfamoylamino, phenylsulfamoylamino, ethylcarbonylamino, ethylthiocarbonylamino, cyclohexylcarbonylamino, benzoylamino, chloroacetylamino, methanesulfonylamino and benzenesulfonylamino);

an amide group having 1 to 18 carbon atoms (preferably 1 to 8 carbon atoms) (for instance, acetamide, acetylmethylamide and acetyloctylamide); a substituted or a unsubstituted ureido group having 1 to 18 carbon atoms (preferably 1 to 8 carbon atoms) (for instance, unsubstituted ureido, methylureido, ethylureido and dimethylureido); a substituted or a unsubstituted carbamoyl group having 1 to 18 carbon atoms (preferably 1 to 8 carbon atoms) (for instance, unsubstituted carbamoyl, methylcarbamoyl, ethylcarbamoyl, n-butylcarbamoyl, t-butylcarbamoyl, dimethylcarbamoyl, morpholinocarbamoyl and pyrrolidinocarbamoyl); an unsubstituted sulfamoyl group or a substituted sulfamoyl group having 1 to 18 carbon atoms (preferably 1 to 8 carbon atoms) (for instance, methylsulfamoyl and phenylsulfamoyl); a halogen atom (for instance, fluorine, chlorine and bromine); a hydroxyl group; a mercapto group; a nitro group; a cyano group; a carboxyl group; a sulfo group; a phosphono group (for instance, diethoxyphosphono); and a heterocyclic group (for instance, oxazole ring, benzoxazole ring, thiazole ring, benzothiazole ring, imidazole ring, benzoimidazole ring, indolenine ring, pyridine ring, morpholine ring, piperidine ring, pyrrolidine ring, sulfolane ring, furan ring, thiophene ring, pyrazole ring, pyrole ring, chromane ring and coumarin ring).

L¹, L² and L³ preferably do not have a substituent group. However, if any, when the solubility of the dye is considered, the substituent group is preferably an alkyl group or a halogen atom and the alkyl group is more preferable.

Now, [—C-(E¹)ₓ-C(═O)—] bonded to Y¹ (hereinafter, for convenience sake, referred to as W¹) and [—C=(E²)_{y}=C(—O⁻)—] bonded to Y² (hereinafter, for convenience sake, referred to as W²), respectively, are in a conjugate state; accordingly, a carbon ring or a heterocyclic ring formed by Y¹ and W¹ and a carbon ring or a heterocyclic ring formed by Y² and W², respectively, are considered to be one of resonant structures. A carbon ring or a heterocyclic ring formed by Y¹ and W¹ or by Y² and W² is preferably a 4- to 7-membered ring and particularly preferably a 5- or 6-membered ring. These rings may further form a condensed ring with another 4- to 7-membered ring. These may have a substituent group. As a substituent group, for instance, those shown as the substituent groups of L¹, L² and L³ can be exemplified. As heteroatoms included in a heterocyclic ring, B, N, O, S, Se and Te can be preferably exemplified. Among these, N, O and S are particularly preferable. Signs x and y are each 0 or 1 and preferably 0.

As a carbon ring or a heterocyclic ring formed by Y¹ and W¹ or by Y² and W², for instance, the following A-1 to A-64 can be exemplified, wherein rings formed by Y¹ and W¹ have a structure represented by A-1 to A-64, and rings formed by Y² and W² have an enol tautomer structure of A-1 to A-64. Among the exemplifications, R^{a}, R^{b} and R^{c} each independently represent a hydrogen atom or a substituent group.

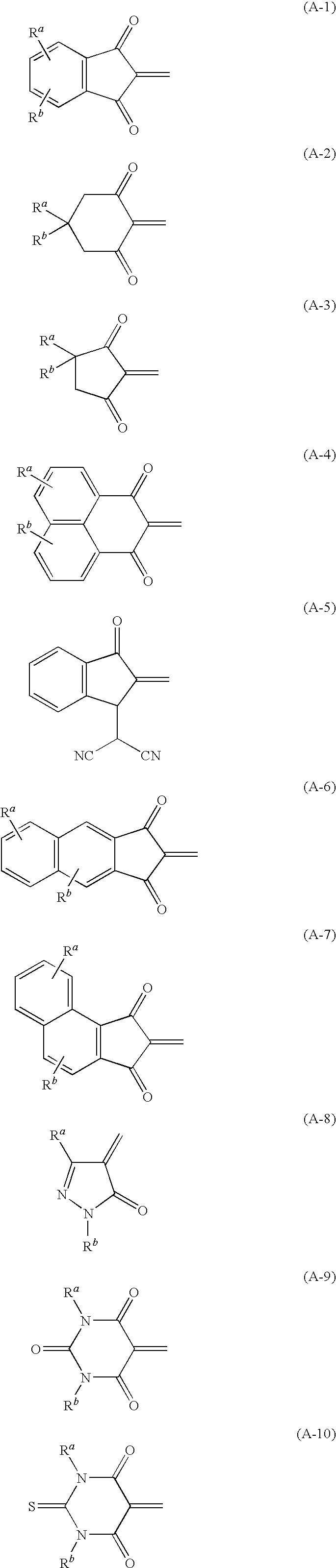

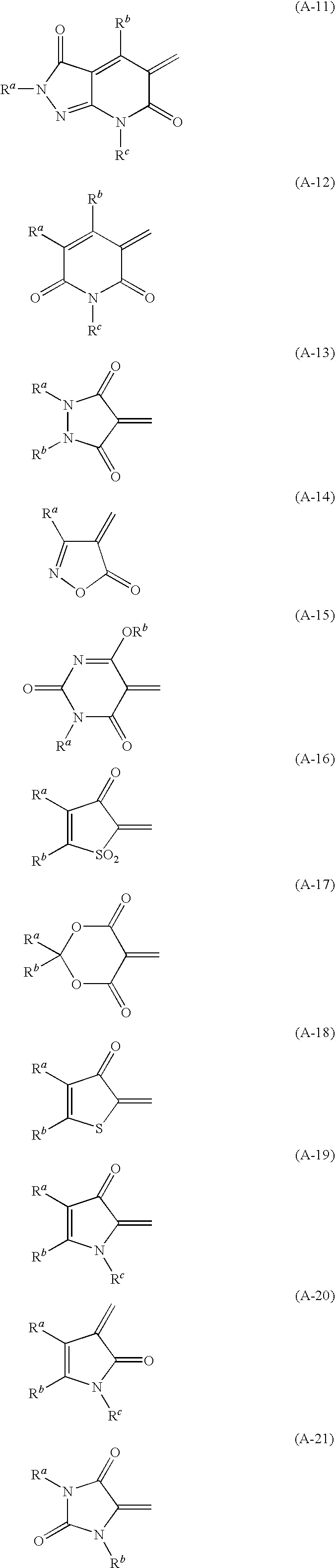

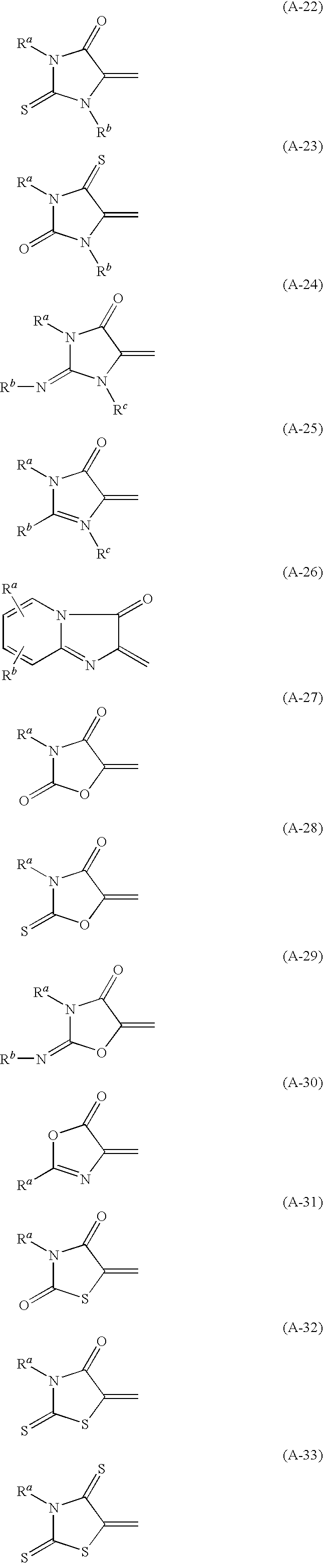

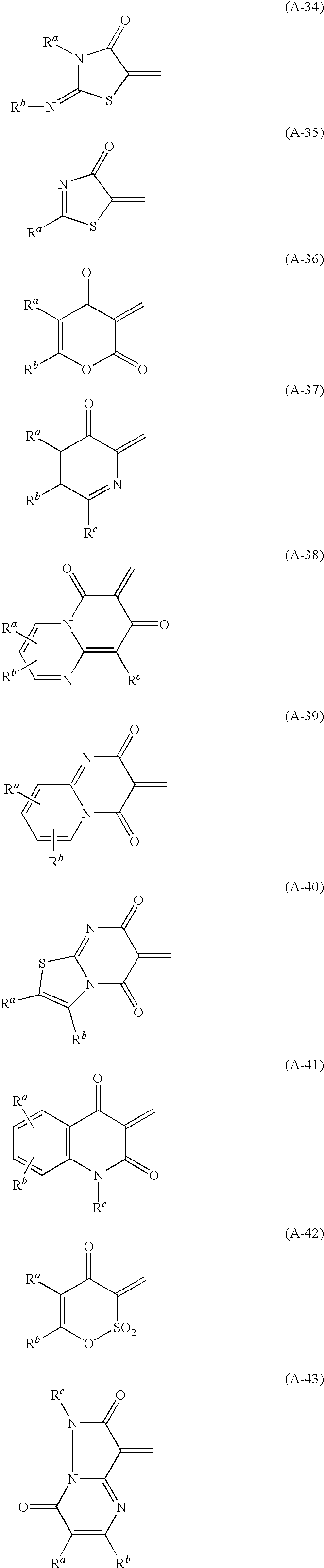

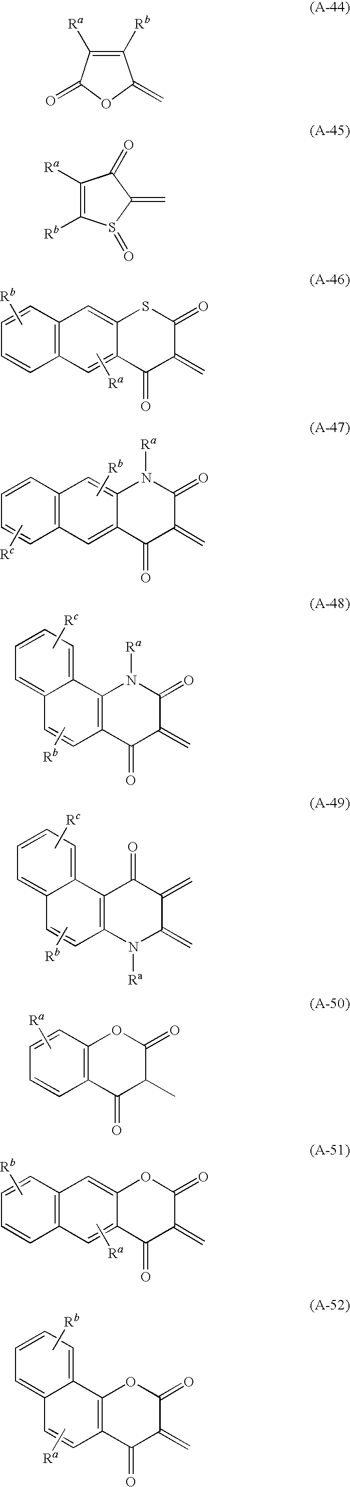

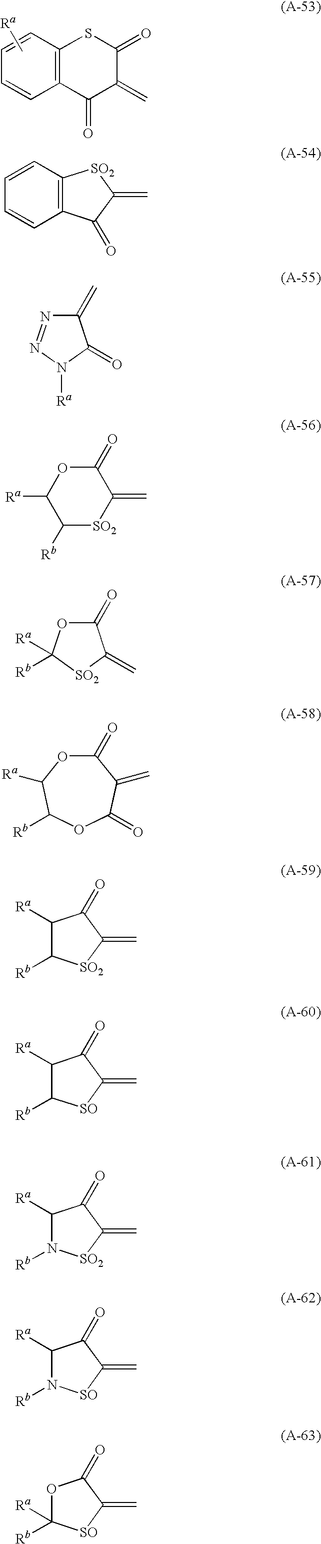

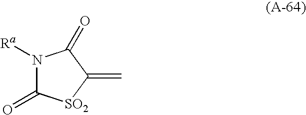

Preferable examples of the carbon rings or heterocyclic rings include those represented by A-8, A-9, A-10, A-11, A-12, A-13, A-14, A-16, A-17, A-36, A-39, A-41, A-54 and A-57. Further preferable examples include those represented by A-8, A-9, A-10, A-13, A-14, A-16, A-17 and A-57. Most preferable examples include those represented byA-9, A-10, A-13, A-17 and A-57.

Substituent groups represented by R^{a}, R^{b} and R^{c}, respectively, are same as those exemplified as substituent groups of the L¹, L² and L³. Furthermore, R^{a}, R^{b} and R^{c}, respectively, may be linked with each other to form a carbon ring or a heterocyclic ring. Examples of the carbon rings include saturated or unsaturated 4- to 7-membered carbon rings such as a cyclohexyl ring, cyclopentyl ring, cyclohexane ring and benzene ring. Furthermore, examples of the heterocyclic rings include saturated or unsaturated 4- to 7-membered heterocyclic rings such as a piperidine ring, piperazine ring, morpholine ring, tetrahydrofuran ring, furan ring, thiophene ring, pyridine ring and pyrazine ring. These carbon rings and heterocyclic rings may be further substituted. Further examples of the substituerit groups are same as those exemplified as substituent groups of the L¹, L² and L³.

In the formula (I), a carbon ring or heterocyclic ring formed by Y¹ and W¹ is preferably substantially same as a carbon ring or heterocyclic ring formed by Y² and W². When these are same, the thermal decomposition temperatures of both rings are same; accordingly, the decomposition rate when a thermal decomposition reaction is caused during recording by laser becomes higher and thereby a higher recording modulation degree can be obtained. That a carbon ring or heterocyclic ring formed by Y¹ and W¹ is substantially same as a carbon ring or heterocyclic ring formed by Y² and W² means that, regardless of difference of expressions of resonance structures, when the respective carbon rings or heterocyclic rings are represented in a neutral state and hydrogen atoms are virtually assigned to carbon atoms that link with a methine chain moiety (=L¹-L²=L³- in the formula (I)), these have the same structure.

In the next place, the cation moiety will be detailed. Examples of cations represented by M^{k+} include, for instance, a quaternary ammonium ion, hydrogen ion or metal ions such as a sodium ion, potassium ion, lithium ion, calcium ion, iron ion and copper ion, metal complex ions, ammonium ion, pyridinium ion, oxonium ion, sulfonium ion, phosphonium ion, selenonium ion and iodonium ion. The quaternary ammonium ion is preferable.

The quaternary ammonium ions can generally be obtained by alkylation (Menshutkin reaction), alkenylation, alkynylation or arylation of a tertiary amine (for instance, trimethylamine, triethylamine, tributylamine, triethanolamine, N-methylpyrrolidine, N-methylpiperidine, N,N-dimethylpiperazine, triethylenediamine and N,N,N′,N′-tetramethylethylenediamine) or a nitrogen-containing heterocyclic ring (for instance, pyridine ring, picoline ring, 2,2′-bipyridyl ring, 4,4′-bipyridyl ring, 1,10-phenanthroline ring, quinoline ring, oxazole ring, thiazole ring, N-methylimidazole ring, pyrazine ring and tetrazole ring).

As the quarternary ammonium ions represented by M^{k+}, quarternary ammonium ions having a nitrogen-containing heterocyclic ring are preferable, and quarternary pyridinium ion is particularly preferable.

In the formula (I), k represents a number necessary for neutralizing the entire molecule.

The cations represented by M^{k+} are more preferably ones represented by the following formula (II). The compounds can be readily obtained normally through the Menshutkin reaction between 2,2′-bipyridyl or 4,4′-bipyridyl and a halide having a target substituent group (for instance, JP-A-61-148162) or an arylation reaction in accordance with a method described in JP-A Nos. 51-16675 and 1-96171.

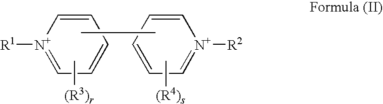

In the formula (II), R³ and R⁴ each independently represent a substituent group, R¹ and R² each independently represent an alkyl group, an alkenyl group, an alkynyl group, an aralkyl group, an aryl group, or a heterocyclic group, and r and s each independently represent an integer of 0 to 4. In the case where r and s are an integer of 2 or more, a plurality of R³ and R⁴, respectively, may be same or different from each other.

The alkyl groups represented by R¹ and R² are preferably substituted or unsubstituted alkyl groups having 1 to 18 carbon atoms and more preferably substituted or unsubstituted alkyl groups having 1 to 8 carbon atoms. These may be straight chain, branched chain or cyclic ones. Examples thereof include methyl, ethyl, n-propyl, isopropyl, n-butyl, isobutyl, t-butyl, n-hexyl, neopentyl, cyclohexyl, adamantyl and cyclopropyl.

As examples of substituent groups of an alkyl group, the followings can be exemplified. That is, examples thereof include a substituted or unsubstituted alkenyl group having 2 to 18 carbon atoms (preferably 2 to 8 carbon atoms) (for instance, vinyl); a substituted or unsubstituted alkynyl group having 2 to 18 carbon atoms (preferably 2 to 8 carbon atoms) (for instance, ethynyl); a substituted or unsubstituted aryl group having 6 to 10 carbon atoms (for instance, phenyl and naphthyl); a halogen atom (for instance, F, Cl and Br); a substituted or unsubstituted alkoxy group having 1 to 18 carbon atoms (preferably 1 to 8 carbon atoms) (for instance, methoxy and ethoxy); a substituted or unsubstituted aryloxy group having 6 to 10 carbon atoms (for instance, phenoxy and p-methoxyphenoxy); a substituted or unsubstituted alkylthio group having 1 to 18 carbon atoms (preferably 1 to 8 carbon atoms) (for instance, methylthio and ethylthio); a substituted or unsubstituted arylthio group having 6 to 10 carbon atoms) (for instance, phenylthio); a substituted or unsubstituted acyl group having 2 to 18 carbon atoms (preferably 2 to 8 carbon atoms) (for instance, acetyl and propionyl);

a substituted or unsubstituted alkylsulfonyl group or arylsulfonyl group having 1 to 18 carbon atoms (preferably 1 to 8 carbon atoms) (for instance, methanesulfonyl and p-toluenesulfonyl); a substituted or unsubstituted acyloxy group having 2 to 18 carbon atoms (preferably 2 to 8 carbon atoms) (for instance, acetoxy and propionyloxy); a substituted or unsubstituted alkoxycarbonyl group having 2 to 18 carbon atoms (preferably 2 to 8 carbon atoms) (for instance, methoxycarbonyl and ethoxycarbonyl); a substituted or unsubstituted aryloxycarbonyl group having 7 to 11 carbon atoms (for instance, naphtoxycarbonyl); a unsubstituted amino group or a substituted amino group having 1 to 18 carbon atoms (preferably 1 to 8 carbon atoms) (for instance, methylamino, dimethylamino, diethylamino, anilino, methoxyphenylamino, chlorophenylamino, pyridylamino, methoxycarbonylamino, n-butoxycarbonylamino, phenoxycarbonylamino, methylcarbamoylamino, ethylthiocarbamoylamino, phenylcarbamoylamino, acetylamino, ethylcarbonylamino, ethylthiocarbamoylamino, cyclohexylcarbonylamino, benzoylamino, chloroacetylamino and methylsulfonylamino);

a substituted or unsubstituted carbamoyl group having 1 to 18 carbon atoms (preferably 1 to 8 carbon atoms) (for instance, unsubstituted carbamoyl, methylcarbamoyl, ethylcarbamoyl, n-butylcarbamoyl, t-butylcarbamoyl, dimethylcarbamoyl, morpholinocarbamoly and pyrrolidinocarbamoyl); a unsubstituted sulfamoyl group or a substituted sulfamoyl group having 1 to 18 carbon atoms (preferably 1 to 8 carbon atoms) (for instance, methylsulfamoyl and phenylsulfamoyl); a cyano group; a nitro group; a carboxy group; a hydroxyl group; and a heterocyclic group (for instance, oxazole ring, benzoxazole ring, thiazole ring, benzothiazole ring, imidazole ring, benzoimidazole ring, indolenine ring, pyridine ring, piperidine ring, pyrrolidine ring, morpholine ring, sulfolane ring, furan ring, thiophene ring, pyrazole ring, pyrole ring, chromane ring and coumarin ring).

The alkenyl groups represented by the R¹ and R² are preferably a substituted or unsubstituted alkenyl group having 2 to 18 carbon atoms and more preferably a substituted or unsubstituted alkenyl group having 2 to 8 carbon atoms. For instance, vinyl, allyl, 1-propenyl and 1,3-butadienyl can be exemplified. As the substituent group of the alkenyl group, those exemplified as the substituent groups of the alkyl group are preferable.

The alkynyl groups represented by the R¹ and R² are preferably a substituted or unsubstituted alkynyl group having 2 to 18 carbon atoms and more preferably a substituted or unsubstituted alkynyl group having 2 to 8 carbon atoms. For instance, ethynyl and 2-propinyl can be exemplified. As the substituent group of the alkynyl group, those exemplified as the substituent groups of the alkyl group are preferable.

The aralkyl groups represented by the R¹ and R² are preferably a substituted or unsubstituted aralkyl group having 7 to 18 carbon atoms. For instance, benzyl and methyl benzyl are preferable. As the substituent group of the aralkyl group, those exemplified as the substituent groups of the alkyl group can be exemplified.

The aryl groups represented by the R¹ and R² are preferably a substituted or unsubstituted aryl group having 6 to 18 carbon atoms. For instance, phenyl and naphthyl can be exemplified. As the substituent group of the aryl group, those exemplified as the substituent groups of the alkyl group are preferable. Other than the above, alkyl groups (for instance, methyl and ethyl) are preferable as well.

The heterocyclic ring groups represented by the R¹ and R² are 5- or 6-membered saturated or unsaturated heterocyclic rings having a carbon atom, nitrogen atom, oxygen atom or sulfur atom. Examples thereof include an oxazole ring, benzoxazole ring, thiazole ring, benzothiazole ring, imidazole ring, benzoimidazole ring, indolenine ring, pyridine ring, piperidine ring, pyrrolidine ring, morpholine ring, sulfolane ring, furan ring, thiophene ring, pyrazole ring, pyrole ring, chromane ring and coumarin ring. The heterocyclic ring groups may be substituted and, as the substituent groups in that case, those exemplified as the substituent groups of the alkyl group are preferable. R¹ and R² are preferably aryl groups that may be substituted.

Substituent groups represented by R³ and R⁴ are same as those exemplified as the substituent groups of the alkyl group. Furthermore, other than these, alkyl groups (for instance, methyl and ethyl) can be exemplified as well.

The r and s each independently represent an integer of 0 to 4, preferably 0 or 1 and most preferably 0.

An oxonol dye represented by the formula (I) has a maximum absorption wavelength longer than a wavelength of the laser beam used for recording information.

An absorption maximum wavelength of an oxonol dye represented by the formula (I) of the invention is measured in a solution of 2,2,3,3-tetrafluoropropanol and means a maximum absorption wavelength in a region where the absorption constant is 1000 L·mol⁻¹·cm⁻¹ or more. When a wavelength of the laser beam is represented by λ (nm), the maximum absorption wavelength of the oxonol dye represented by the formula (I) is more preferably in the range of (λ+10) to (λ+110) nm and most preferably in the range of (λ+20) to (λ+70) nm.

Specifically, the absorption maximum wavelength means a wavelength of a maximum point when measuring absorption in a range of 300 to 900 nm with a 1 cm long cell of a 2,2,3,3-tetrafluoropropanol solution of the oxonol dye (the concentration is appropriately controlled so that the maximum absorbance in 300 to 900 nm may be substantially 1). However, the absorption constant at the maximum point is 1000 L·mol⁻¹·cm⁻¹ or more. When there is a plurality of maximum absorption points that satisfy the above conditions, a maximum absorption wavelength having the shortest wavelength is adopted.

In the oxonol dye represented by the formula (I) of the invention, the anion moiety thereof is preferably represented by the following formula (I-1). The cation moiety thereof is preferably represented by the following formula (I-3).

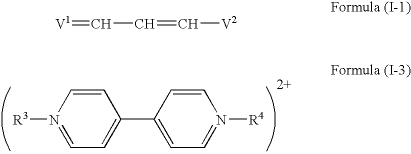

In the formula (I-1), V¹ is any one selected from the following group 1, and V² is any one selected from the following group 2.

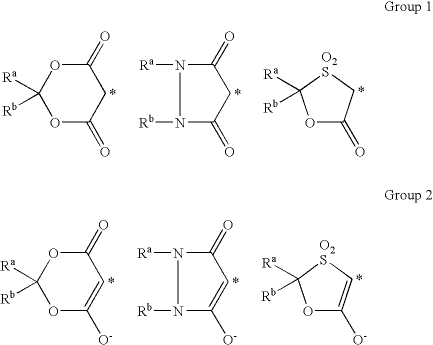

The anion moiety represented by the formula (I-1) is particularly excellent in thermal decomposition characteristics (being speedily decomposed when it is heated); accordingly, the anion moiety can be preferably used in an optical information recording medium of the invention.

Furthermore, in the chemical formulae, R^{a} and R^{b} each independently represent a hydrogen atom or a substituent group. Specifically, these are same as examples of R^{a} and R^{b} described in the A-1 to A-64. * in the chemical formulae represents a bonding position in formula (I-1).

In the formula (I-3), R³ and R⁴ each independently represent an aryl group that may be substituted.

The cation moiety represented by the formula (I-3) can inhibit dye fading; accordingly, the storability of an optical information recording medium can be improved.

As to dye compounds that are represented by the formula (I) and used in the invention, examples of the anion moieties (shown by [B-1 to 15]) and the cation moieties (shown by [C-1 to 15]) in the formulae (I-1), (I-2) and (I-3) are specifically exemplified below. However, the invention is not restricted thereto. In the following specific examples, an asterisk mark [*] shows a position of bond.

| | |
|---|---|
| | Formula (I-1) |
| 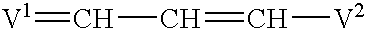 | |

| No. | V¹ | V² |
|---|---|---|
| B-1 | 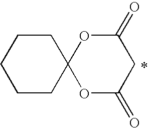 | 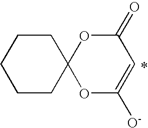 |
| B-2 | 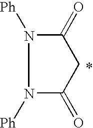 | 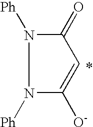 |
| B-3 | 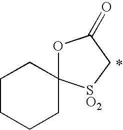 | 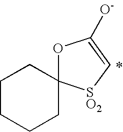 |
| B-4 | 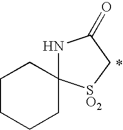 | 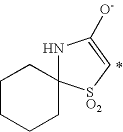 |
| B-5 | 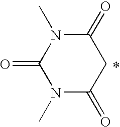 | 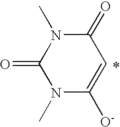 |
| B-6 | 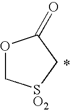 | 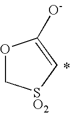 |
| B-7 | 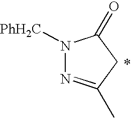 | 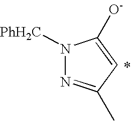 |
| B-8 | 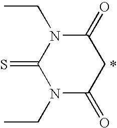 | 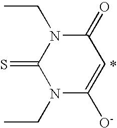 |
| B-9 | 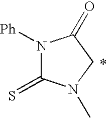 | 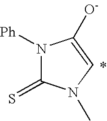 |
| B-10 | 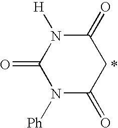 | 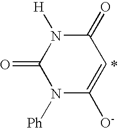 |

| | |
|---|---|
| | Formula (I-2) |
| 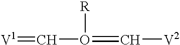 | |

| No. | V¹ | V² | R |
|---|---|---|---|
| B-11 | 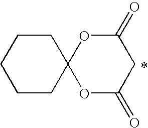 | 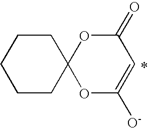 | Ph |
| B-12 | 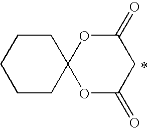 | 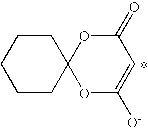 | Me |
| B-13 | 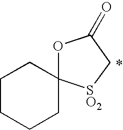 | 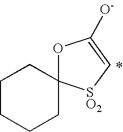 | Ph |
| B-14 | 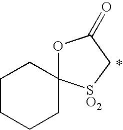 | 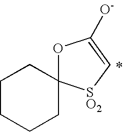 | Cl |
| B-15 | 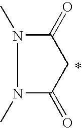 | 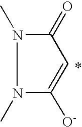 | Ph |

| | |
|---|---|
| | Formula (I-3) |
| 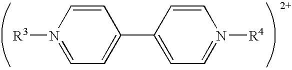 | |

| No. | R³ | R⁴ |
|---|---|---|
| C-1 | 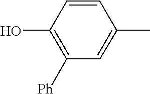 | 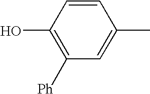 |
| C-2 | 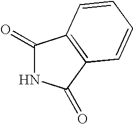 | 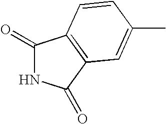 |
| C-3 | 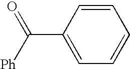 | 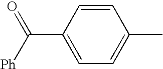 |
| C-4 | 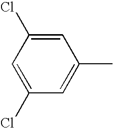 | 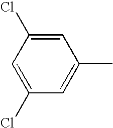 |
| C-5 | 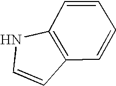 | 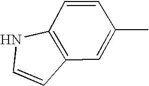 |
| C-6 | 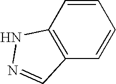 | 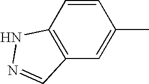 |
| C-7 | 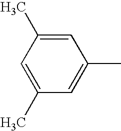 | 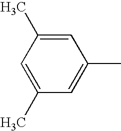 |
| C-8 | 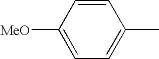 | 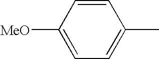 |
| C-9 | 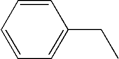 | 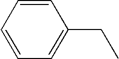 |
| C-10 | C₂H₅ | C₂H₅ |
| C-11 | C-12 | C-13 |
| 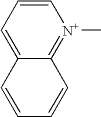 | 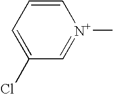 | N(Bu)₄⁺ |
| C-14 | C-15 | |
| Na⁺ | 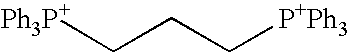 | |

Examples of more preferable specific compounds used in the invention and the absorption maximum wavelengths measured in a 2,2,3,3-tetrafluoropropanol solution are shown in the following Table 1. In the Table 1, compound Nos. (S-1 to 10) are, as shown in the table, formed by combining an anion moiety and a cation moiety.

TABLE 1

| | | | Absorption |
|---|---|---|---|
| | | | Maximum |
| Compound No. | Anion Moiety | Cation Moiety | Wavelength (nm) |
| S-1 | B-1 | C-1 | 453 |
| S-2 | B-1 | C-2 | 453 |
| S-3 | B-1 | C-3 | 453 |
| S-4 | B-3 | C-1 | 445 |
| S-5 | B-3 | C-2 | 445 |
| S-6 | B-3 | C-3 | 445 |
| S-7 | B-2 | C-1 | 490 |
| S-8 | B-2 | C-3 | 490 |
| S-9 | B-2 | C-3 | 490 |
| S-10 | B-7 | C-4 | 510 |

The dye compounds according to the invention represented by the formula (I) may be used alone or in combination of two or more. Alternatively, the dye compound according to the invention may be used in combination with other dye compounds.

In the recording layer of the information recording medium of the invention, in order to improve the light resistance of the recording layer, various kinds of anti-fading agents can be contained. As the anti-fading agent, an organic oxidant and a singlet oxygen quencher can be used. As the organic oxidant, the compounds described in JP-A No. 10-151861 can be preferably used. As the singlet oxygen quencher, metal complexes and those described in publications such as already known patent specifications can be used. Specific examples thereof include ones described in JP-A Nos. 58-175693, 59-81194, 60-18387, 60-19586, 60-19587, 60-35054, 60-36190, 60-36191, 60-44554, 60-44555, 60-44389, 60-44390, 60-54892, 60-47069, 63-209995, 4-25492, Japanese Patent Application Publication (JP-B) Nos. 1-38680 and 6-26028; German Patent No. 350399; and Nippon Kagaku Kaishi, October (1992), p. 1141. Preferable examples of the singlet oxygen quencher include the compounds represented by the following formula (III):

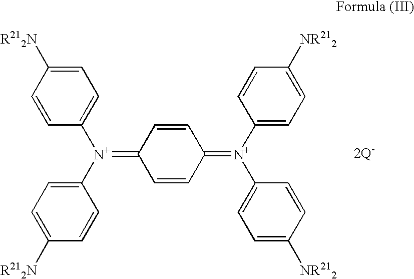

wherein R²¹ represents an alkyl group that may have a substituent and Q⁻ represents an anion.

In formula (III), R²¹ is generally an alkyl group having 1 to 8 carbon atoms that may have a substituent, and preferably an unsubstituted alkyl group having 1 to 6 carbon atoms. Examples of the substituent of the alkyl group include a halogen atom (for example, F and Cl), an alkoxy group (for example, methoxy and ethoxy), an alkylthio group (for example, methylthio and ethylthio), an acyl group (for example, acetyl and propionyl), an acyloxy group (for example, acetoxy and propionyloxy), a hydroxy group, an alkoxy carbonyl group (for example, methoxy carbonyl and ethoxycarbonyl), an alkenyl group (for example, vinyl), and an aryl group (for example, phenyl and naphthyl). A halogen atom, an alkoxy group, an alkylthio group, and an alkoxy carbonyl group are preferable. Preferable examples of the Q⁻ anion include ClO₄⁻, AsF₆⁻, BF₄⁻, and SbF₆⁻. Examples of the compound (compound Nos. III-1˜III-8) represented by formula (III) are shown in the following Table 2.

TABLE 2

| Compound No. | R²¹ | Q⁻ |
|---|---|---|
| III-1 | CH₃ | ClO₄⁻ |
| III-2 | C₂H₅ | ClO₄⁻ |
| III-3 | n-C₃H₇ | ClO₄⁻ |
| III-4 | n-C₄H₉ | ClO₄⁻ |
| III-5 | n-C₅H₁₁ | ClO₄⁻ |
| III-6 | n-C₄H₉ | SbF₆⁻ |
| III-7 | n-C₄H₉ | BF₄⁻ |
| III-8 | n-C₄H₉ | AsF₆⁻ |

The amount of the anti-fading agent such as a singlet oxygen quencher is, based on the amount of the dye, generally in the range of 0.1 to 50 mass percent, preferably in the range of 0.5 to 45 mass percent, more preferably in the range of 3 to 40 mass percent and particularly preferably in the range of 5 to 25 mass percent.

### EMBODIMENTS OF OPTICAL INFORMATION RECORDING MEDIUM

In embodiment (1), the optical information recording medium according to the invention includes a dye-containing recording layer (write-once recording layer) and a cover layer having a thickness of 0.01 to 0.5 mm in that order on a substrate having a thickness of 0.7 to 2 mm; and in embodiment (2), the optical information recording medium according to the invention includes a dye-containing write-once recording layer and a protective substrate having a thickness of 0.1 to 1.0 mm in that order on a substrate having a thickness of 0.1 to 1.0 mm. In embodiment (1), the pre-groove formed on the substrate preferably has a track pitch of 50 to 500 nm, a groove width of 25 to 250 nm, and a groove depth of 5 to 150 nm; and in embodiment (2), the pre-groove formed on the substrate preferably has a track pitch of 200 to 600 nm, a groove width of 50 to 300 nm, a groove depth of 30 to 200 nm, and a wobble amplitude of 10 to 50 nm.

The optical information recording medium of embodiment (1) has at least a substrate, a write-once recording layer and a cover layer, and these important components will be described first one by one.

### [Substrate According to Embodiment (1)]

A pre-groove (guide groove) having a track pitch, a groove width (half value width), a groove depth, and a wobble amplitude in the ranges as below may be formed on the substrate of embodiment (1). The pre-groove is formed for obtaining a recording density higher than that of CD-R or DVD-R, and is preferable, for example, when the optical information recording medium according to the invention is used as a medium for a blue violet laser.

The pre-groove track pitch may be in the range of 50 to 500 nm, and the upper limit is preferably 420 nm or less, more preferably 370 nm or less, and still more preferably 330 nm or less. The lower limit is preferably 100 nm or more, more preferably 200 nm or more, and still more preferably 260 nm or more.

A track pitch of less than 50 nm may lead to difficulty in forming the pre-groove accurately, generating a problem of crosstalk, while that of more than 500 nm may cause a problem of decrease in recording density.

The pre-groove width (half value width) may be in the range of 25 to 250 nm, and the upper limit thereof is preferably 200 nm or less, more preferably 170 nm or less, and still more preferably 150 nm or less. The lower limit thereof is preferably 50 nm or more, more preferably 80 nm or more, and still more preferably 100 nm or more.

A pre-groove width of less than 25 nm may result in insufficient transfer of the groove during molding and increase in the error rate during recording, while that of more than 250 nm may result in broadening the pit formed during recording, causing crosstalk or insufficient modulation.

The pre-groove depth may be in the range of 5 to 150 nm, and the upper limit thereof is preferably 100 nm or less, more preferably 70 nm or less, and still more preferably 50 nm or less. The lower limit thereof is preferably 10 nm or more, more preferably 20 nm or more, and still more preferably 28 nm or more.

A pre-groove depth of less than 5 nm may result in insufficient recording modulation, while that of more than 150 nm may result in drastic decrease in reflectance.

The upper limit of the angle of the pre-groove is preferably 80° or less, more preferably 70° or less, still more preferably 60° or less, and particularly preferably 50° or less. Furthermore, the lower limit of the angle of the pre-groove is preferably 20° or more, more preferably 30° or more, and still more preferably 40° or more.

A pre-groove angle of less than 20° may result in insufficient tracking error signal amplitude, while that of more than 80° may result in difficulty in molding.

As a substrate in the invention, various materials used as substrate materials in existing optical information recording medium can be selected and used.

Specific examples of the materials include glass; polycarbonates; acrylic resins such as polymethylmethacrylate; vinyl chloride base resins such as polyvinyl chloride and vinyl chloride copolymer; epoxy resins; amorphous polyloefins; polyesters; and metals such as aluminum, and a combination of two or more kinds thereof can be used if desired.

Among the materials mentioned above, from viewpoints of the moisture resistance, the dimensional stability and the low cost, thermoplastic resins such as amorphous polyolefins and polycarbonate are preferable, and polycarbonate is particularly preferable. In the case of using such resins, a substrate can be manufactured by means of injection molding. The thickness of the substrate may be in the range of 0.7 to 2 mm. Preferably it is in the range of 0.9 to 1.6 mm, and more preferably, in the range of 1.0 to 1.3 mm.

On a surface of the substrate at the side where a light reflective layer mentioned below is disposed, in order to improve the planarity and to increase the adhesive force, an undercoat layer is preferably formed.

Examples of the materials of the undercoat layer include polymers such as polymethyl methacrylate, acrylic acid-methacrylic acid copolymers, styrene-maleic anhydride copolymers, polyvinyl alcohol, N-methylol acrylamide, styrene-vinyl toluene copolymers, chlorosulfonated polyethylene, cellulose nitrate, polyvinyl chloride, chlorinated polyolefin, polyester, polyimide, vinyl acetate-vinyl chloride copolymers, ethylene-vinyl acetate copolymers, polyethylene, polypropylene and polycarbonate; and a surface modifier such as silane coupling agents.

The undercoat layer can be formed by preparing a coating solution by dissolving or dispersing the material mentioned above in an adequate solvent, followed by coating the coating solution on the surface of the substrate by means of a coating method such as a spin coat method, a dip coat method or an extrusion coat method. In general, the film thickness of the undercoat layer is in the range of 0.005 to 20 μm, and preferably in the range of 0.01 to 10 μm.

### [Write-Once Recording Layer According to Embodiment (1)]

A write-once recording layer of embodiment (1) may be prepared by preparing a coating solution by dissolving an oxonol dye according to the invention together with a binder and others in a suitable solvent, and forming a coated film by coating the coating solution on a substrate or a light-reflective layer described below, and drying the coated film. Here, the write-once recording layer may be either mono-layered or multi-layered. In the case of the write-once recording layer having a multi-layered configuration, the recording layer can be formed by carrying out the coating step a plurality of times.

The concentration of the oxonol dye according to the invention in the coating solution is generally in the range of 0.01 to 15 mass percent, preferably in the range of 0.1 to 10 mass percent, more preferably in the range of 0.5 to 5 mass percent, and most preferably in the range of 0.5 to 3 mass percent.

Examples of the solvent for the coating solution include esters such as butyl acetate, ethyl lactate and cellosolve acetate; ketones such as methyl ethyl ketone, cyclohexanone, and methyl isobutyl ketone; chlorinated hydrocarbons such as dichloromethane, 1,2-dichloroethane and chloroform; amides such as dimethylformamide; hydrocarbons such as methylcyclohexane; ethers such as tetrahydrofuran, ethyl ether, and dioxane; alcohols such as ethanol, n-propanol, isopropanol, n-buthanol, and diacetone alcohol; fluorinated solvents such as 2,2,3,3-tetrafluoropropanol; and glycol ethers such as ethylene glycol monomethyl ether, ethylene glycol monoethyl ether and propylene glycol monomethyl ether.

The solvents mentioned above, in consideration of the solubility of the oxonol dye used, can be used singularly or in a combination of two or more kinds thereof. Furthermore, in the coating solution, various kinds of the additives such as an antioxidant, a UV absorbent, a plasticizer and a lubricant can be added in accordance with the purpose.

As the coating method, a spray method, a spin coat method, a dip method, a roll coat method, a blade coat method, a doctor roll method and a screen print method can be exemplified.

At the coating, a temperature of the coating solution is preferably in the range of 23 to 50 degrees centigrade, more preferably in the range of 24 to 40 degrees centigrade, among these particularly preferably in the range of 23 to 50 degrees centigrade.

The thickness of the write-once recording layer formed in this way is, on the groove (the projected portion on the substrate), preferably 300 nm or less, more preferably 250 nm or less, further more preferably 200 nm or less, and particularly preferably 180 nm or less. The lower limit thereof is preferably 30 nm or more, more preferably 50 nm or more, further more preferably 70 nm or more, and particularly preferably 90 nm or more.

Furthermore, the thickness of the write-once recording layer is, on the land (the depressed portion on the substrate), preferably 400 nm or less, more preferably 300 nm or less, and further more preferably 250 nm or less. The lower limit thereof is preferably 70 nm or more, more preferably 90 nm or more, and further more preferably 110 nm or more.

Still furthermore, the ratio of the thickness of the write-once recording layer on the groove to the thickness of the write-once recording layer on the land is preferably 0.4 or more, more preferably 0.5 or more, further more preferably 0.6 or more, and particularly preferably 0.7 or more. The upper limit thereof is preferably less than 1, more preferably 0.9 or less, further more preferably 0.85 or less, and particularly preferably 0.8 or less.

In the case of the coating solution containing a binder, examples of the binder include the natural organic polymers such as gelatin, cellulose derivatives, dextran, rosin and rubber; and synthetic organic polymers such as hydrocarbon resins such as polyethylene, polypropylene, polystylene and polyisobutylene, vinyl resins such as polyvinylchloride, polyvinylidene chloride and polyvinylchloride-polyvinyl acetate copolymers, acrylic resins such as polymethyl acrylate and polymethyl methacrylate, and polyvinyl alcohol, chlorinated polyethylene, epoxy resin, butyral resin, rubber derivatives and initial condensates of thermosetting resins such as phenol formaldehyde resin. In the case of using a binder as a material of the recording layer, the amount of the binder used is generally in the range of 0.01 to 50 times the amount of the dye (mass ratio), and more preferably in the range of 0.1 to 5 times the amount of the dye (mass ratio).

### [Cover Layer According to Embodiment (1)]

A cover layer according to embodiment (1) may be bonded through an adhesive or a pressure sensitive adhesive on the write-once recording layer mentioned above or a barrier layer mentioned below.

As far as a film made of a transparent material is used, there is no particular restriction on the cover layer used in the invention. However, polycarbonates; acrylic resins such as polymethyl methacrylate; vinyl chloride resins such as polyvinylchloride and vinyl chloride copolymers; epoxy resins; amorphous polyolefins; polyester; and cellulose triacetate can be preferably used. Among these, polycarbonate or cellulose triacetate can be preferably used. “Transparent” means that the transmittance to light used for recording and reproducing is 80 percent or more.

In the cover layer, as far as the effect of the invention is not disturbed, various kinds of additives can be included. For example, the cover layer may include a UV absorbent that cuts light whose wavelength is 400 nm or less and/or a dye that cuts light whose wavelength is 500 nm or more. Furthermore, as the physical properties of a surface of the cover layer, the surface roughness is preferably 5 nm or less in both the two-dimensional roughness parameter and the three-dimensional roughness parameter. From a viewpoint of the collecting power of light used in recording and reproducing, the birefringence of the cover layer is preferably 10 nm or less.

The thickness of the cover layer is appropriately provided according to the wavelength and NA of the laser beam irradiated for recording and reproducing. However, in the invention, it is in the range of 0.01 to 0.5 mm, and more preferably in the range of 0.05 to 0.12 mm. The total thickness of the cover layer and a layer of an adhesive agent or a pressure sensitive adhesive is preferably in the range of 0.09 to 0.11 mm, and more preferably in the range of 0.095 to 0.105 mm. On the light incidence surface of the cover layer, in order to inhibit the light incidence surface from being flawed while the optical information recording medium is manufactured, a protective layer (a hard coat layer) may be disposed.

As the adhesive that is used to bond the cover layer, for example, a UV curable resin, EB curable resin and a thermosetting resin can be preferably used, and particularly preferably the UV curable resin can be used.

In the case of using a UV curable resin as the adhesive, the UV curable resin as it is or a coating solution prepared by dissolving the UV curable resin in an adequate solvent such as methyl ethyl ketone and ethyl acetate may be supplied from a dispenser onto a surface of a barrier layer. In order to inhibit warpage of the manufactured optical information recording medium, the UV curable resin constituting the adhesive layer preferably has a small curing shrinkage percentage. As an example of such a UV curable resin, UV curable resins such as trade name SD-640, manufactured by Dainippon Ink and Chemicals, Incorporated can be exemplified.

It is preferable that a predetermined amount of the adhesive is coated on a barrier layer surface to be bonded, a cover layer is disposed thereon, the adhesive is evenly spread between the surface to be bonded and the cover layer by spin coating, and the adhesive is cured.

The thickness of the adhesive layer made of such adhesive is preferably in the range of 0.1 to 100 μm, more preferably in the range of 0.5 to 50 μm, and further more preferably in the range of 10 to 30 μm.

As the pressure sensitive adhesive used to bond the cover layer, an acrylic, a rubber base and a silicon base pressure sensitive adhesive can be used. However, from viewpoints of the transparency and the durability, the acrylic pressure sensitive adhesives are preferable. As such acrylic pressure sensitive adhesives, those which are prepared mainly from 2-ethylhexyl acrylate or n-butyl acrylate and in which a short chain alkyl acrylate or methacrylate such as methyl acrylate, ethyl acrylate and methyl methacrylate, and acrylic acid, methacrylic acid, acrylamide derivative, maleic acid, hydroxyl ethyl acrylate or glycidyl acrylate, which can work as a crosslinking point with a cross-linking agent, are copolymerized in order to increase the cohesive force can be preferably used. By properly regulating a blending ratio and the kinds of the main component, the short-chain component and the component to add the cross-linking point, the glass transition temperature (Tg) and cross-linking density can be varied.

As the cross-linking agent used together with the pressure sensitive adhesive, for example, isocyanate cross-linking agents can be exemplified. Examples of such isocyanate cross-linking agents include isocyanates such as trilene diisocyanate, 4,4′-diphenylmethane diisocyanate, hexamethylene diisocianate, xylylene diisocyanate, naphthylene-1,5-diisocyanate, o-toluidine isocyanate, isohorone diisocyanate and triphenylmethane triisocyanate; or products of the isocyanates and polyalcohols; or polyisocyanates produced by the condensation of the isocyanates. Examples of commercially available products of the isocyanates include trade names: Coronate L, Coronate HL, Coronate 2030, Coronate 2031, Millionate MR and Millionate HTL manufactured by Nippon Polyurethane Industry Co. Ltd.; trade names: Takenate D-102, Takenate D-110N, Takenate D-200 and Takenate D-202 manufactured by Takeda Chemical Industries Co., Ltd.; and trade names: Desmodule L, Desmodule IL, Desmodule N and Desmodule HL manufactured by Sumitomo Bayer Co., Ltd.

The pressure sensitive adhesive, after a predetermined amount thereof is coated uniformly on the barrier layer surface to be bonded and a cover layer is disposed thereon, may be cured, or, after a predetermined amount of the pressure sensitive adhesive is beforehand coated on one surface of the cover layer to form a pressure sensitive adhesive coated film and the coated film is laminated to the surface to be bonded, may be cured.

Furthermore, as the cover layer, a commercially available adhesive film on which a pressure sensitive adhesive layer is disposed beforehand may be used. The thickness of the pressure sensitive adhesive layer made of the pressure sensitive adhesive is preferably in the range of 0.1 to 100 μm, more preferably in the range of 0.5 to 50 μm, and further more preferably in the range of 10 to 30 μm.

### [Other Layers According to Embodiment (1)]

The optical information recording medium according to embodiment (1) may have, as far as the effect of the invention is not damaged, in addition to the indispensable layers mentioned above, other optional layers. As the optional layers, for example, a label layer having a desired image formed on the reverse side of the substrate (the opposite side to the side where the write-once recording layer is formed), a light reflective layer (described later) disposed between the substrate and the write-once recording layer, a barrier layer (described later) disposed between the write-once recording layer and the cover layer, and an interface layer disposed between the light reflective layer and the write-once recording layer can be exemplified. The label layer is formed using UV curable resins, thermosetting resins, and thermal dry resins. All of the indispensable layers as well as the optional layers can be a singular layer or may have a multi-layered structure.

### [Light Reflective Layer According to Embodiment (1)]

In the optical information recording medium of embodiment (1), in order to increase the reflectance to the laser beam or to impart a function of improving the recording and reproducing properties, a light reflective layer is preferably disposed between the substrate and the write-once recording layer.

The light reflective layer can be formed on a substrate by vacuum evaporation, sputtering or ion plating of a light reflective material having high reflectance to the laser beam. The layer thickness of the light reflective layer is generally in the range of 10 to 300 nm and preferably in the range of 50 to 200 nm. In addition, the reflectance is preferably 70 percent or more.

Examples of the light reflective materials high in reflectance include metals and metalloids such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn and Bi, or stainless steel. The light reflective materials may be used singularly, or in combinations of two or more kinds thereof, or alloys thereof also can be used. Among these, Cr, Ni, Pt, Cu, Ag, Au, Al and stainless steel are preferable. Particularly preferably, Au, Ag, Al or the alloys thereof can be used, and most preferably, Au, Ag or alloys thereof can be used.

### [Formation of Barrier Layer (Intermediate Layer) in Embodiment (1)]

In the optical information recording medium of embodiment (1), it is preferable to form a barrier layer between the write-once recording layer and the cover layer. The barrier layer is disposed in order to increase the storability of the write-once recording layer, to increase the adhesiveness between the write-once recording layer and the cover layer, to control the reflectance, and to control the thermal conductivity.

There is no restriction on materials used for the barrier layer, as far as these are materials that can transmit light that is used for recording and reproducing and also can exhibit the above functions. For example, in general, they are preferably materials low in the permeability of gas and water and are preferably dielectrics. Specifically, materials made of nitrides, oxides, carbides and sulfides of Zn, Si, Ti, Te, Sn, Mo and Ge are preferable. Among these, ZnS, MoO₂, GeO₂, TeO, SiO₂, TiO₂, ZnO, ZnS—SiO₂, SnO₂ and ZnO—Ga₂O₃ are preferable, and ZnS—SiO₂, SnO₂ and ZnO—Ga₂O₃ are more preferable.

The barrier layer can be formed by a vacuum film formation method such as vacuum evaporation, DC sputtering, RF sputtering or ion plating. Among these, it is more preferable to use the sputtering method, and the RF sputtering can be further more preferably used. The thickness of the barrier layer according to the invention is preferably in the range of 1 to 200 nm, more preferably in the range of 2 to 100 nm, and further more preferably in the range of 3 to 50 nm.

Hereinafter, the optical information recording medium of embodiment (2) will be described. The optical information recording medium of embodiment (2) is an optical information recording medium having a laminated layer structure, and typical examples of the layer structures are as follows:

(1) First layer structure having a write-once recording layer, a light-reflective layer, and an adhesive layer formed in that order on a substrate and additionally a protective substrate formed on the adhesive layer.

(2) Second layer structure having a write-once recording layer, a light-reflective layer, a protective layer, and an adhesive layer formed in that order on a substrate and additionally a protective substrate formed on the adhesive layer.

(3) Third layer structure having a write-once recording layer, a light-reflective layer, a protective layer, an adhesive layer, and a protective layer formed in that order on a substrate, and additionally a protective substrate formed on the protective layer.

(4) Fourth layer structure having a write-once recording layer, a light-reflective layer, a protective layer, an adhesive layer, a protective layer, and a light-reflective layer formed in that order on a substrate and additionally a protective substrate formed on the light-reflective layer.

(5) Fifth layer structure having a write-once recording layer, a light-reflective layer, an adhesive layer, and a light-reflective layer formed in that order on a substrate and additionally a protective substrate formed on the light-reflective layer.

The layer structures (1) to (5) are mere exemplifications, and the layer structure is not limited to those described above, and some of the layers may be changed in order or may be eliminated. Further, an additional write-once recording layer may be formed at the protective substrate side, and in such a case, an optical information recording medium allowing recording and reproduction at both faces is obtained. Further, each layer may be a single layer or may contain multiple layers.

The optical information recording medium according to the invention will be described below, by taking a media having a write-once recording layer, a light-reflective layer, an adhesive layer, and a protective substrate formed in that order on a substrate as an example.

### [Substrate According to Embodiment (2)]

A pre-groove (guide groove) having a track pitch, a groove width (half value width), a groove depth, and a wobble amplitude in the following ranges may be formed on the substrate of embodiment (2). The pre-groove, which is formed for obtaining a recording density higher than that of CD-R or DVD-R, is preferable, for example, when the optical information recording medium according to the invention is used as a medium for a blue violet laser.

The pre-groove track pitch may be in the range of 200 to 600 nm, and the upper limit is preferably 500 nm or less, more preferably, 450 nm or less, and still more preferably 430 nm or less. The lower limit is preferably 300 nm or more, more preferably 330 nm or more, and still more preferably 370 nm or more.

A track pitch of less than 200 nm may make it difficult to form the pre-groove accurately, causing a problem of crosstalk, while that of more than 600 nm may cause a problem of deterioration in recording density.

The pre-groove width (half value width) may be in the range of 50 to 300 nm, and the upper limit is preferably 250 nm or less, more preferably 200 nm or less, and still more preferably 180 nm or less. The lower limit is preferably 100 nm or more, more preferably 120 nm or more, and still more preferably 140 nm or more.

A pre-groove width of less than 50 nm may lead to insufficient transfer of the groove during molding and increase in the error rate during recording, while that of more than 300 nm may lead to broadening the pit formed during recording, causing a problem of crosstalk or insufficient modulation.

The pre-groove depth may be in the range of 30 to 200 nm, and the upper limit is preferably 170 nm or less, more preferably 140 nm or less, and still more preferably 120 nm or less. The lower limit is preferably 40 nm or more, more preferably 50 nm or more, and still more preferably 60 nm or more. A pre-groove depth of less than 30 nm may lead to insufficient recording modulation, while that of more than 200 nm may lead to drastic decrease in reflectance.

Any of various materials used for the substrates in conventional optical information recording media may be selected and used in production of the substrate for use in embodiment (2), and typical examples and preferable examples thereof are the same as those described for the substrate in embodiment (1).

The thickness of the substrate may be in the range of 0.1 to 1.0 mm, preferably in the range of 0.2 to 0.8 mm, and more preferably in the range of 0.3 to 0.7 mm.

An undercoat layer is preferably formed on the surface of the substrate at the side where a write-once recording layer as mentioned below is formed, for improvement in planarity and adhesive strength. Typical and preferable examples of the materials, coating methods and layer thickness of the undercoat layer are the same as those described for the undercoat layer of embodiment (1).

### [Write-Once Recording Layer According to Embodiment (2)]

Details of the write-once recording layer of embodiment (2) are the same as those of the write-once recording layer of embodiment (1).

### [Light-Reflective Layer According to Embodiment (2)]

In embodiment (2), a light-reflective layer may be formed on the write-once recording layer for improvement in reflectance to laser beam and record reproduction properties. Details of the light-reflective layer of embodiment (2) are the same as those of the light-reflective layer of embodiment (1).

### [Adhesive Layer According to Embodiment (2)]

The adhesive layer of embodiment (2) is any layer that is formed for improving the adhesion between the light-reflective layer and the protective substrate.

The material for the adhesive layer is preferably a photocurable resin, and in particular, a photocurable resin having low curing shrinkage for prevention of disk warpage.

Examples of the photocurable resins include UV-curable resins (UV-curable adhesives) such as trade names: SD-640 and SD-347; manufactured by Dainippon Ink and Chemicals, Inc., and the like. The thickness of the adhesive layer is preferably in the range of 1 to 1000 μm for providing the layer with a sufficient elasticity.

### [Protective Substrate According to Embodiment (2)]

The same material as that for the substrate described above in the same shape can be used as the protective substrate of embodiment (2) (dummy substrate). The thickness of the protective substrate may be in the range of 0.1 to 1.0 mm, preferably in the range of 0.2 to 0.8 mm, and still more preferably in the range of 0.3 to 0.7 mm.

### [Protective Layer According to Embodiment (2)]

The optical information recording medium of embodiment (2) may have a protective layer for physical and chemical protection of the light-reflective layer, write-once recording layer, or the like, depending on its layer structure. Examples of the materials for the protective layer include inorganic materials such as ZnS, ZnS—SiO₂, SiO, SiO₂, MgF₂, SnO₂, and Si₃N₄; and organic materials such as thermoplastic resin, thermosetting resin, and UV-curable resin.

The protective layer can be prepared, for example, by bonding a film prepared by extrusion of a plastic resin with an adhesive onto a light-reflective layer. Alternatively, it may be formed by another method such as vacuum deposition, sputtering, or coating.

The protective layer, when made of a thermoplastic resin or thermosetting resin, may be formed by preparing a coating solution by dissolving the resin in a suitable solvent and coating and drying the coating solution. When a UV-curable resin is used, the protective layer may be formed by coating the resin as it is or a coating solution prepared by dissolving the resin in a suitable solvent, and then hardening the coated film by UV irradiation. Various additives such as antistatic agent, antioxidant, and UV absorbent may be additionally added to such a coating solution, according to its application. The thickness of the protective layer is generally in the range of 0.1 μm to 1 mm.

### [Other Layers According to Embodiment (2)]

In the optical information recording medium of embodiment (2), as far as the effect of the invention is not disturbed, other optional layers can be included in addition to the layers above. Details of the other optional layers are the same as those of the other layers of embodiment (1).

### <Optical Information Recording Method>

The optical information recording method according to the invention may be performed using an optical information recording medium such as that of embodiment (1) or (2), for example, as follows: First, a beam for recording such as a semiconductor laser beam is irradiated on the optical information recording medium, while rotating at a constant linear velocity (0.5 to 10 m/sec) or a constant angular velocity, from the substrate side or from the protective layer side. It appears that the information is recorded by a mechanism such that the photoirradiation raises the temperature in local regions of the recording layer due to absorption of the light, resulting in change in physical or chemical properties (for example, pit formation) thereof, so that the optical properties are changed. In the invention, a semiconductor laser beam having an oscillation wavelength ranging from 390 to 440 nm may be used as the recording light. Examples of preferable light sources include a blue-violet semiconductor laser having an oscillation wavelength ranging from 390 to 415 nm and a blue-violet SHG laser having a central oscillation wavelength of 425 nm obtained by halving the wavelength of an infrared semiconductor laser having a central oscillation wavelength of 850 nm using an optical waveguide device. The blue-violet semiconductor laser having an oscillation wavelength ranging from 390 to 415 nm is particularly preferable in terms of recording density. Information recorded as above can be reproduced by irradiating the medium with the semiconductor laser beam from the substrate side or from the protective layer side, while rotating the medium at the same constant linear velocity as mentioned above and detecting the reflected light.

### EXAMPLES

Examples of the present invention are described below.

### Examples 1 to 10

### Preparation of Optical Information Recording Medium

### (Preparation of Substrate)

A polycarbonate resin substrate having a thickness of 1.1 mm, an external diameter of 120 mm, and an internal diameter of 15 mm and having a spiral pre-groove (track pitch: 320 nm, groove width: on-groove width 120 nm, groove depth: 35 nm, groove inclination angle: 65°, wobble amplitude: 20 nm) was prepared by injection molding. Mastering of the stamper used in injection molding was performed using laser cutting (351 nm).

### (Formation of Light Reflective Layer)

On the substrate, using trade name: Cube, manufactured by Unaxis, in an atmosphere of Ar, by means of DC sputtering, an APC light reflective layer (Ag: 98.1 mass percent, Pd: 0.9 mass percent, and Cu: 1.0 mass percent) as a vacuum deposition layer with a film thickness of 100 nm was formed. The film thickness of the light reflective layer was controlled by a sputter time.

### (Formation of Write-Once Recording Layer)

Two grams of each of compounds (S-1) to (S-10) in the Table 1 was added to 100 ml of 2,2,3,3-tetrafluoropropanol to dissolve, whereby a dye containing coating solution was prepared. On the light reflective layer, the prepared dye containing coating solution was coated by means of the spin coat method, with the number of revolutions varying in the range of 300 to 4000 rpm, under conditions of 23 degrees centigrade and 50 percent RH. Then, it was stored for 1 hr at 23 degrees centigrade and 50 percent RH, and a write-once recording layer (with a thickness on the groove of 120 nm and a thickness on the land of 170 nm) was formed.

After the write-once recording layer was formed, in a clean oven, annealing treatment was carried out. The substrates were supported on a vertical stack pole distanced with spacers and the annealing treatment was applied at 80 degrees centigrade for 1 hr.

### (Formation of Barrier Layer)

After that, on the write-once recording layer, using trade name: Cube, manufactured by Unaxis, in an atmosphere of Ar, by means of RF sputtering, a barrier layer that was 5 nm in thickness and made of ZnO—Ga₂O₃ (ZnO:Ga₂O₃=7:3 (by mass ratio)) was formed.

### (Bonding of Cover Layer)

As a cover layer, using a polycarbonate film (Trade name: Teijin Pure Ace, thickness: 80 μm) having an internal diameter of 15 mm, an external diameter of 120 mm, and one surface on which a pressure sensitive adhesive was applied, a total of thicknesses of the pressure sensitive adhesive layer and the polycarbonate film was controlled so as to be 100 μm.

Then, after the cover layer was disposed on the barrier layer so that the barrier layer and the pressure sensitive adhesive layer may come into contact, the cover layer was pressed using a pressing member to bond the layers with each other.

### Comparative Examples 1 to 4

Optical information recording media were prepared in the same manner as in Examples, except that the compounds (S-1) to (S-10) were replaced with the comparative compounds (A) to (D) represented by the following chemical formulae.

The comparative compound (C) is an oxonol dye, but has a maximum absorption wavelength in a 2,2,3,3-tetrafluoropropanol solution of 378 nm, which is shorter than the wavelength of the later-described recording laser (403 nm and 405 nm).

Comparative Compound A (Specific Example (b) Described in JP-A No. 11-58758)

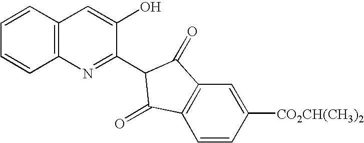

Comparative Compound B (Specific Example (c) Described in JP-A No. 11-58758)

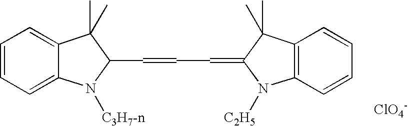

Comparative Compound C (Specific Example (32) Described in JP-A No. 2001-71638)

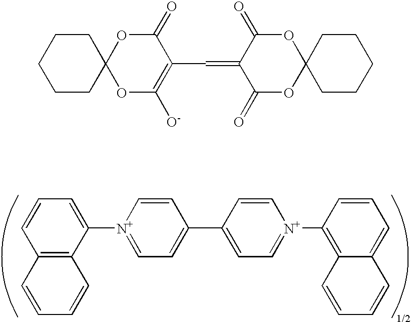

Comparative Compound D (Specific Example (34) Described in JP-A No. 2001-71638)

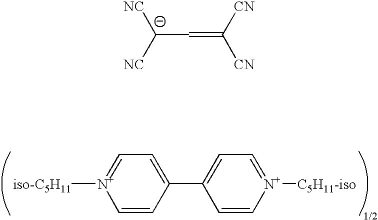

The optical information recording media of Examples 1 to 10 and Comparative Examples 1 to 4 were thus prepared.

### Evaluation of Optical Information Recording Medium

### (Evaluation of C/N Ratio (Carrier Wave to Noise Ratio))

The C/N ratio (after recording) of each optical information recording medium prepared was measured by a spectrum analyzer (Trade name: Pulstec MSG2, manufactured by Pulstec Industrial Co. Ltd.), when a 0.16-μm signal (2T) was recorded and reproduced using a recording/reproducing evaluation machine having a 403-nm laser and a pickup having a NA of 0.85 (Trade name: DDU1000; manufactured by Pulstec Industrial Co. Ltd.) under the conditions of a clock frequency of 66 MHz and a linear velocity of 5.28 m/s. The recording for evaluation was carried out on the groove using an optical information recording method of the invention. The recording power was 5.2 mW, and the reproduction power was 0.3 mW. Further, the same measurement was carried out after storing the optical information recording medium for 24 hours in an environment of 60° C. and 80% humidity. Results are shown in the following Table 3. When the C/N ratio (after recording) is 25 dB or more, the reproduction signal intensity is sufficiently high and thus preferable in practical use.

### Examples 11 to 20

### Preparation of Optical Information Recording Medium

### (Preparation of Substrate)

A injection molded substrate made of polycarbonate resin having a thickness of 0.6 mm, an external diameter of 120 mm, and an internal diameter of 15 mm, and a spiral pre-groove (track pitch: 400 nm, groove width: 170 nm, groove depth: 100 nm, groove angle: 65°, wobble amplitude: 20 nm) was prepared. Mastering of the stamper used in injection molding was conducted using laser cutting (351 nm).

### (Formation of Write-Once Recording Layer)

Two grams of each of compounds (S-1) to (S-10) in the Table 1 was added to 100 ml of 2,2,3,3-tetrafluoropropanol to dissolve, whereby a dye containing coating solution was prepared. On the substrate, the prepared dye containing coating solution was coated by means of the spin coat method, with the number of revolutions varying in the range of 300 to 4000 rpm, under conditions of 23 degrees centigrade and 50 percent RH. Then, it was stored for 1 hr at 23 degrees centigrade and 50 percent RH, and a write-once recording layer (with a thickness on the groove of 170 nm and a thickness on the land of 120 nm) was formed.

After the write-once recording layer was formed, in a clean oven, annealing treatment was carried out. The substrates were supported on a vertical stack pole distanced with spacers and the annealing treatment was applied at 80 degrees centigrade for 1 hr.

### (Formation of Light Reflective Layer)

On the write-once recording layer, using trade name: Cube, manufactured by Unaxis, in an atmosphere of Ar, by means of DC sputtering, an APC light reflective layer (Ag: 98.1 mass percent, Pd: 0.9 mass percent, and Cu: 1.0 mass percent) as a vacuum deposition layer with a film thickness of 100 nm was formed. The film thickness of the light reflective layer was controlled by a sputter time.

### (Bonding of Protective Substrate)

An ultraviolet-curable resin (SD661, manufactured by Dainippon Ink and Chemicals) was coated on the light-reflective layer by spin coating, then a protective substrate made of polycarbonate (the same as the above substrate except that no pre-groove was formed) is bonded thereon, and cured by ultraviolet ray irradiation. The thickness of the adhesive layer of the ultraviolet-curable resin in the optical information recording medium prepared was 25 μm.

### Comparative Examples 5 to 8

Optical information recording media were prepared in the same manner as in Examples 11 to 20, except that the compounds (S-1) to (S-10) were replaced with comparative compounds (A) to (D) represented by the above chemical formulae.

Thus, optical information recording media of Examples 11 to 20 and Comparative Examples 5 to 8 were prepared.

### Evaluation of Optical Information Recording Medium

### (Evaluation of C/N Ratio (Carrier Wave to Noise Ratio))

The C/N ratio (after recording) of each optical information recording medium prepared was measured by a spectrum analyzer (Trade name: Pulstec MSG2, manufactured by Pulstec Industrial Co. Ltd.), when a 0.2-μm signal (2T) was recorded and reproduced using a recording/reproducing evaluation machine having a 405-nm laser and a pickup having a NA of 0.65 (Trade name: DDU1000; manufactured by Pulstec Industrial Co. Ltd.) under the conditions of a clock frequency of 64.8 MHz and a linear velocity of 6.6 m/s. The recording for evaluation was carried out on the groove using an optical information recording method of the invention. The recording power was 12 mW, and the reproduction power was 0.5 mW. Further, the same measurement was carried out after storing the optical information recording medium for 24 hours in an environment of 60° C. and 80% humidity. Results are shown in the following Table 3. When the C/N ratio (after recording) is 25 dB or more, the reproduction signal intensity is sufficiently high and the recording properties are preferable. When the C/N ratio is 25 dB or more after storing for 24 hours in an environment of 60° C. and 80% humidity, the storability is sufficiently high and thus preferable in practical use.

TABLE 3

| | | | C/N(dB) |
|---|---|---|---|
| | | | (After storing for 24 |
| | | | hours under an |
| | | | environment of 60° C. |
| | Dye Compound | C/N(dB) | and 80% humidity) |
| Example 1 | (S-1) | 55 | 53 |
| Example 2 | (S-2) | 50 | 47 |
| Example 3 | (S-3) | 52 | 49 |
| Example 4 | (S-4) | 56 | 51 |
| Example 5 | (S-5) | 53 | 50 |
| Example 6 | (S-6) | 50 | 46 |
| Example 7 | (S-7) | 55 | 50 |
| Example 8 | (S-8) | 45 | 42 |
| Example 9 | (S-9) | 42 | 41 |
| Example 10 | (S-10) | 40 | 39 |
| Example 11 | (S-1) | 52 | 50 |
| Example 12 | (S-2) | 51 | 46 |
| Example 13 | (S-3) | 49 | 45 |
| Example 14 | (S-4) | 53 | 49 |
| Example 15 | (S-5) | 54 | 51 |
| Example 16 | (S-6) | 52 | 49 |
| Example 17 | (S-7) | 50 | 47 |
| Example 18 | (S-8) | 44 | 39 |
| Example 19 | (S-9) | 39 | 35 |
| Example 20 | (S-10) | 38 | 30 |
| Comparative | (A) | 18 | 13 |
| example 1 | | | |
| Comparative | (B) | 10 | 2 |
| example 2 | | | |
| Comparative | (C) | 40 | 22 |
| example 3 | | | |
| Comparative | (D) | 38 | Impossible to measure |
| example 4 | | | because of |
| | | | crystallization |
| Comparative | (A) | 16 | 11 |
| example 5 | | | |
| Comparative | (B) | 10 | 3 |
| example 6 | | | |
| Comparative | (C) | 30 | 20 |
| example 7 | | | |
| Comparative | (D) | 28 | Impossible to measure |
| example 8 | | | because of |
| | | | crystallization |

From results of the Table 3, it is found that optical information recording media 1 to 20 having a recording layer that contains an oxonol dye according to the invention are higher in the reproduction signal intensity in comparison with comparative examples 1 to 8 and excellent in storability under high temperature and high humidity conditions. From what are mentioned above, it has been confirmed that when the oxonol dye according to the invention is used, an optical information recording medium excellent in recording characteristics and storability can be obtained. In particular, it has been confirmed that since the above advantage can be obtained when a laser beam having a wavelength shorter than that for CD-R and DVD-R is used, higher density optical information recording medium and information recording method can be provided.

The disclosure of Japanese Patent Application No. 2006-060245 is incorporated by reference herein.

1-7. (canceled)

8. An information recording method comprising irradiating a laser beam having a wavelength of 440 nm or less to an optical information recording medium to record information, wherein said optical information recording medium comprises: on a substrate, a recording layer in which information can be recorded by irradiating the laser beam having a wavelength of 440 nm or less, wherein the recording layer comprises an oxonol dye that has a maximum absorption wavelength longer than the wavelength of the laser beam.

9. The information recording method of claim 8, wherein the oxonol dye is represented by the following formula (I): 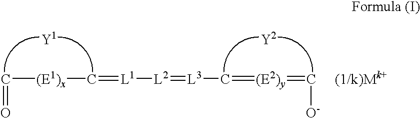
wherein L¹, L² and L³ each independently represent a methine chain that may have a substituent group; Y¹ and Y² each represent an atomic group necessary for forming a carbon ring or a heterocyclic ring together with C-(E¹)ₓ-C or C=(E²)_{y}=C; E¹ and E² each represent an atomic group necessary for completing a conjugate double bond chain; x and y each denote 0 or 1; M^{k+} represents a cation; and k denotes a number necessary for neutralizing charges of the entire molecule.

10. The information recording method of claim 9, wherein an anion moiety in the formula (I) is represented by the following formula (I-1): 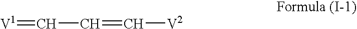
wherein V¹ is any one selected from the following group 1, and V² is any one selected from the following group 2: 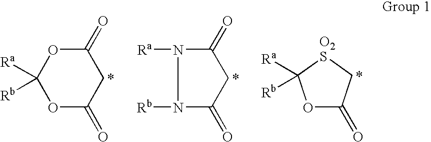
wherein R^{a} and R^{b} each independently represent a hydrogen atom or a substituent group, and * represents a bonding position in formula (I-1) 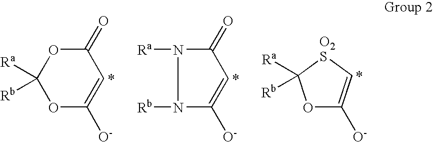
wherein R^{a} and R^{b} each independently represent a hydrogen atom or a substituent group, and * represents a bonding position in formula (I-1).

11. The method of claim 8, wherein the oxonol dye is represented by the following formula (I): 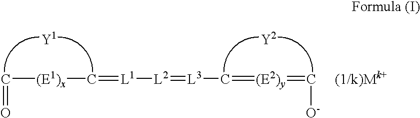
wherein L¹, L² and L³ each independently represent a methine chain that may have a substituent group; Y¹ and Y² each represent an atomic group necessary for forming a carbon ring or a heterocyclic ring together with C-(E¹)ₓ-C or C=(E²)_{y}=C; E¹ and E² each represent an atomic group necessary for completing a conjugate double bond chain; x and y each denote 0 or 1; M^{k+} represents a cation; and k denotes a number necessary for neutralizing charges of the entire molecule, and
wherein a cation moiety in the formula (I) is represented by the following formula (I-3): 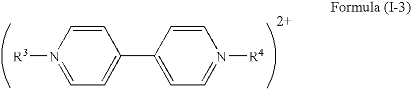
wherein R³ and R⁴ each independently represent an aryl group that may be substituted.

12. The method of claim 8, wherein the optical information recording medium further comprises a reflective layer.

13. The method of claim 8, wherein the optical information recording medium further comprises a protective layer.

14. The method of claim 8, wherein the substrate is a transparent disc substrate comprising a groove having a track pitch of 0.05 to 0.6 μm on a surface thereof, and the recording layer is formed on a side where the groove is formed.
